(19) United States
(12) Patent Application Publication
(10) Pub. No.: US 2008/0155662 A1
(43) Pub. Date: Jun. 26, 2008

(54) METHOD OF HANDLING USER AUTHENTICATION IN A HETEROGENEOUS AUTHENTICATION ENVIRONMENT

(75) Inventor: Venkateswara R. Vykunta, Fremont, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/613,802

(22) Filed: Dec. 20, 2006

(51) Int. Cl. H04L 9/32

(52) U.S. Cl. 726/5

(57) ABSTRACT

An embodiment of the present invention is a method that effectuates the handling user authentication in a heterogeneous information technology (IT) environment having multiple authentication sources.

### CROSS-REFERENCE TO RELATED APPLICATIONS

This application contains subject matter, which is related to the subject matter of the following co-pending applications, each of which is assigned to the same assignee as this application, International Business Machines Corporation of Armonk, N.Y. Each of the below listed applications is hereby incorporated herein by reference in its entirety:

entitled “METHOD OF HANDLING USER GROUPS IN DESKTOP AND WEB BASED APPLICATIONS IN A HETEROGENEOUS AUTHENTICATION ENVIRONMENT”, Docket No: SJO920060076US1.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method that effectuates the handling of user authentication in a heterogeneous information technology (IT) environment having multiple authentication sources.

2. Description of Background

A heterogeneous authentication environment in an information technology (IT) organization is supported by multiple authentication sources like Lightweight Directory Access Protocol (LDAP) servers, NIS and many custom application authentication sources. Managing user authentication of desktop and web based applications in such an environment is very difficult especially when the user base of the applications is located across multiple authentication sources.

Many desktop and web based applications get around this problem by exporting users located in one authentication source to another authentication source using an export-import mechanism like scripts.

There are many problems with this approach. One such problem can be that the user information is now located in multiple authentication sources. This can make changing user information very difficult. As example, updating a user password, updating user phone number, and or updating other user data is a non-trivial task, as it requires synchronization of user data across all authentication sources. Furthermore, in this configuration, if user data synchronization is not performed correctly and in a timely manner, user data accessed by other applications in the IT environment will become outdated very quickly.

Another such problem can be that user management becomes more difficult as there is no common repository for holding user data. In addition, if a single user is defined across multiple authentication sources, resolving user authentication and hence user privileges can become very difficult to manage.

As such, the aforementioned problems and long felt need for a better method of handling user authentication in a heterogeneous IT environment in part gives rise to the present invention.

### SUMMARY OF THE INVENTION

The shortcomings of the prior art are overcome and additional advantages are provided through the provision of a method of handling user authentication in desktop and web based applications in heterogeneous authentication environments, the method comprising: creating a plurality of user authentication modules one of the plurality of user authentication modules is created for each of a plurality of authentication sources using a common interface; creating a proxying module for proxying authentication requests to the plurality of authentication modules; storing a plurality of authentication priorities for each of the plurality of authentication modules in a database; configuring a plurality of applications to use the proxying module for user authentication; allowing a user to send a login request to an application using the proxying module, the application being a specific one of the plurality of applications; determining by way of the module if the user is a native user of the application; reading, upon successful user authentication, a plurality of user data information from one of the plurality of authentication sources, the plurality of user data information is related to the user; and presenting the plurality of user data to the application.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which is a method that effectuates the handling of user authentication in a heterogeneous information technology (IT) environment having multiple authentication sources.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a method that effectuates the handling of user authentication in a heterogeneous information technology (IT) environment having multiple authentication sources.

The detailed description explains the preferred embodiments of the invention, together with advantages and features, by way of example with reference to the drawings.

### DETAILED DESCRIPTION OF THE INVENTION

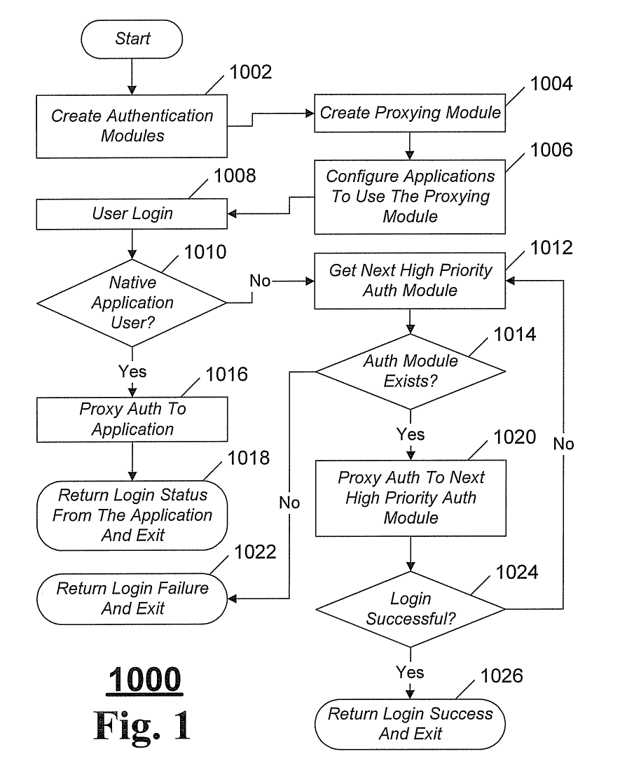

Turning now to the drawings in greater detail, it will be seen that in FIG. 1 there is illustrated one example of a method that effectuates the handling of user authentication in a heterogeneous information technology (IT) environment having multiple authentication sources.

In an exemplary embodiment, handling user authentication in a heterogeneous IT environment can be difficult to manage. In this regard, the present invention effectuates a method that creates a user authentication module for each of the authentication sources using a common interface; creates a module for proxying authentication requests to the authentication modules previously created; stores the authentication priorities of each of the authentication modules previously created in a database; and then configures desktop and web based applications to use the proxying module previously created for user authentication.

Continuing, when a user logs into the configured applications the proxying module performs the login process. If the user is a native user defined within the application then the method proxies user authentication requests to the native authentication mechanism used by the application. If the user is not a native user, the proxying module then tries to verify the user's credentials by validating the user's authentication request against each of the authentication modules previously created in the order of priority as specified in the authentication priorities stored in the database.

In an exemplary embodiment, checking of the user's credentials continue with each of the authentication modules in the priority specified by the authentication priorities stored in the database until a successful login occurs or until all authentication modules are tried for the user's authentication. If a successful user authentication occurs, user data information is read from the authenticating source and is presented to the application otherwise the user's login attempt fails. The method begins in block 1002.

In block 1002 a plurality of authentication modules are created. Each of the plurality of authentication modules is created for each of a plurality of authentication sources using a common interface. Processing then moves to block 1004.

In block 1004 a proxying module is created. In addition, authentication priorities of each of the plurality of authentication modules previously created is stored in a database. Processing then moves to block 1006.

In block 1006 each of a plurality of applications are configured to use the proxying module. The plurality of applications can be desktop applications or web based applications. Processing then moves to block 1008.

In block 1008 a user is allowed to attempt to log into one of the plurality of applications. Processing then moves to decision block 1010.

In decision block 1010 a determination is made as to whether or not the user is a native application user. If the resultant is in the affirmative that is the user is a native application user then processing moves to block 1016. If the resultant is in the negative that is the user is not a native application user then processing moves to block 1012.

In block 1012 the next highest priority authentication modules is selected from the database. Processing then moves to decision block 1014.

In decision block 1014 a determination is made as to whether or not the authentication module exists. If the resultant is in the affirmative that is the authentication module exists then processing moves to block 1020. If the resultant is in the negative that is the authentication module does not exist then processing moves to block 1022.

In block 1016 the user's authentication request (also referred to as login request) is proxied to the application. Processing then moves to block 1018.

In block 1018 the login status from the application is returned and the routine is exited.

In block 1020 the user authentication request (also referred to as the login request) is proxied to the next highest priority authentication module as selected in block 1012. Processing then moves to decision block 1024.

In block 1022 the failed login status is returned and the routine is exited.

In decision block 1024 a determination is made as to whether or not the user's login request was successful. If the resultant is in the affirmative that is the user's login request was successful then processing moves to block 1026. If the resultant is in the negative that is the user's login request was not successful then processing returns to block 1012.

In block 1026 the successful login status is returned and the routine is exited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of handling user authentication in desktop and web based applications in heterogeneous authentication environments, said method comprising:
creating a plurality of user authentication modules one of said plurality of user authentication modules is created for each of a plurality of authentication sources using a common interface;
creating a proxying module for proxying authentication requests to said plurality of authentication modules;
storing a plurality of authentication priorities for each of said plurality of authentication modules in a database;
configuring a plurality of applications to use said proxying module for user authentication;
allowing a user to send a login request to an application using said proxying module, said application being a specific one of said plurality of applications;
determining by way of said module if said user is a native user of said application;
reading, upon successful said user authentication, a plurality of user data information from one of said plurality of authentication sources, said plurality of user data information is related to said user; and
presenting said plurality of user data to said application.

2. The method in accordance with claim 1, wherein determining includes if said user is said native user then said user authentication is performed by way of native authentication mechanism used by said application.

3. The method in accordance with claim 2, wherein determining includes if said user is not said native user then said proxying module attempts to authenticate said user credentials by validation against one of said plurality of authentication modules, wherein specific one of said plurality of authentication modules used is selected in accordance with said plurality of authentication priorities.

4. The method in accordance with claim 3, wherein determining includes if said user is not said native user then checking to see if specific one of said plurality of authentication modules selected exists.

5. The method in accordance with claim 4, wherein determining is repeated until a successful said user authentication occurs.

6. The method in accordance with claim 5, wherein said plurality of authentication priorities are set to determine the sequence in which each of said plurality of authentication sources will be utilized for the purpose of said user authentication.

7. The method in accordance with claim 6 wherein, said plurality of applications are either a desktop application, or a web based application.
